(19) United States
(12) Patent Application Publication
(10) Pub. No.: US 2010/0332303 A1
(43) Pub. Date: Dec. 30, 2010

(54) SYSTEMS AND METHODS FOR REWARDING CUSTOMER LOYALTY

(76) Inventor: Thomas Glynn Vaught, Brighton, MI (US)

Correspondence Address: FOLEY & LARDNER, 555 South Flower Street, SUITE 3500, LOS ANGELES, CA, 90071-2411, US

(21) Appl. No.: 12/495,436

(22) Filed: Jun. 30, 2009

(51) Int. Cl. G06Q 10/00; G06Q 30/00

(52) U.S. Cl. 705/14.15; 705/34; 705/35

(57) ABSTRACT

Systems and methods allow for rewarding customer loyalty, such as rewarding members of a fitness club for longevity of membership to the fitness club. A method of an embodiment includes storing information about a customer who is scheduled to be charged payment amounts that are specified by a payment plan. The method further includes receiving, by a server computer over a network from a client computer, a request to enroll the customer in a payment reducing plan. Also, the method further includes automatically reducing, by the server computer, the payment amounts charged to the customer over time in accordance with a payment reduction schedule for the payment reducing plan while the customer remains enrolled in the payment reducing plan.

### BACKGROUND OF THE INVENTION

1. Field of the Invention

Embodiments of the present invention relate generally to systems and methods for rewarding customers and, in various embodiments, to computer-network based systems and methods for rewarding customers for longevity of loyalty to a provider.

2. Related Art

Providers of goods, services, facilities, or the like, such as fitness clubs, internet service providers, insurance companies, or the like, often make large investments in attracting new customers. Such providers generally want to retain paying customers for continued revenue generation and, thus, are generally very sensitive to customer attrition or customer turnover that results in a loss of existing customers. In addition to focusing on quality customer service for retaining customers, some providers also reward customers through gifts, prizes, points for redemption, or the like, to engender and express appreciation for customer loyalty. Customer attrition continues to be a concern among many companies, and loss of existing clients is often especially painful during hard economic times.

### SUMMARY OF THE DISCLOSURE

A method in accordance with an embodiment of the present invention allows for rewarding customer loyalty. The method includes storing information about a customer who is scheduled to be charged payment amounts that are specified by a payment plan. The method further includes receiving, by a server computer over a network from a client computer, a request to enroll the customer in a payment reducing plan. The method also includes automatically reducing, by the server computer, the payment amounts charged to the customer over time in accordance with a payment reduction schedule for the payment reducing plan while the customer remains enrolled in the payment reducing plan.

### BRIEF DESCRIPTION OF THE DRAWINGS

FIG. 1 is a flow diagram of a system in accordance with one embodiment of the present invention;

FIG. 2 is an enrollment form in accordance with one embodiment of the present invention; and

FIGS. 3A, 3B, and 3C are flow diagrams of a method in accordance with a second embodiment of the present invention.

### DETAILED DESCRIPTION OF PREFERRED EMBODIMENTS

Embodiments of the present invention relate generally to systems and methods for rewarding customers and, in various embodiments, to computer-network based systems and methods for rewarding customers for longevity of loyalty to a provider. Customers that have contracts with a provider to make scheduled payments according to a payment plan are provided with the option of enrolling in a payment reducing plan that allows for a reduction in payment amounts over time. Such payment reducing plans may help to reduce customer attrition by rewarding customers for longevity of loyalty to a provider.

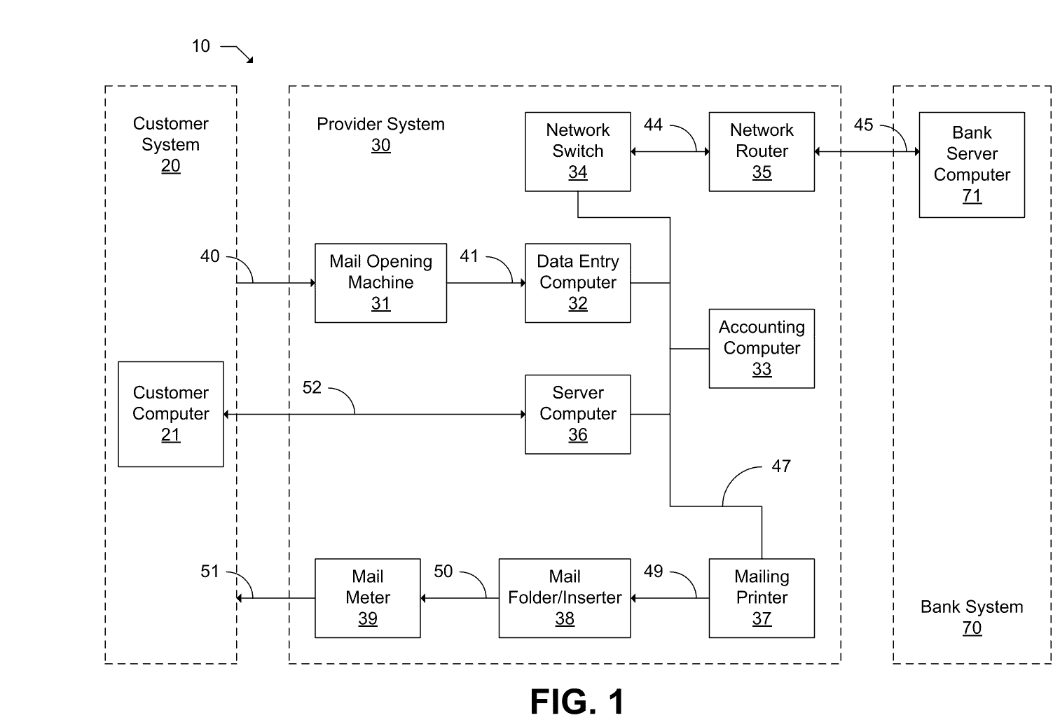

FIG. 1 is a flow diagram of a system 10 in accordance with an embodiment of the present invention. The system 10 includes a customer system 20, a provider system 30, and a bank system 70. The customer system 20 may be located, for example, at a house of a customer. The provider system 30 may be located, for example, at a business location of a provider. The bank system 70 may be located, for example, at a bank. The customer system 20 includes a customer computer 21, which may be a personal computer, or the like. The bank system 70 includes a bank server computer 71, which may be a server computer, or the like.

The provider system 30 includes a mail opening machine 31, a data entry computer 32, an accounting computer 33, a network switch 34, a network router 35, a server computer 36, a mailing printer 37, a mail folder/inserter 38, a mail meter 39, and a network 47. The mail opening machine 31 is configured to open envelopes to allow for extracting contents from the envelopes. The data entry computer 32 comprises a personal computer, or the like. The accounting computer 33 comprises a personal computer, or the like. The data entry computer 32 functions as a client computer to the server computer 36.

The network switch 34 is configured to transfer data between networks. The network router 35 is configured to route data between networks. The mailing printer 37 is configured to print documents for mailing. The mail folder/inserter 38 is configured to fold documents and to insert the folded documents into envelopes for mailing. The mail meter 39 is configured to add proper postage to envelopes to pay for delivery of the envelopes through the postal system. The network 47 comprises one or more of a local area network (LAN), a wide area network (WAN), or the like, and allows for communicating data between the data entry computer 32, the accounting computer 33, the network switch 34, the server computer 36, and the mailing printer 37. The provider system 30 further includes a network 44 for communicating data between the network switch 34 and the network router 35, and the network switch 34 is configured to communicate data between the network 47 and the network 44.

The system 10 further includes a network 52 for communicating data between the customer computer 21 of the customer system 20 and the server computer 36 of the provider system 30. The network 52 comprises a WAN, such as the Internet. The system 10 further includes a network 45 for communicating data between the network router 35 of the provider system 30 and the bank server computer 71 of the bank system 70. The network 45 comprises a WAN, such as the Internet.

Envelopes may be mailed from a location of the customer system 20 to a location of the provider system 30 and may be provided to the mail opening machine 31 as indicated by an arrow 40. Mail that has been opened by the mail opening machine 31 may be provided to a user of the data entry computer 32 as indicated by an arrow 41. Documents printed by the mailing printer 37 may be provided to the mail folder/inserter 38 as indicated by an arrow 49. Envelopes from the mail folder/inserter 38 may be provided to the mail meter 39 as indicated by an arrow 50. Envelopes that are supplied with postage by the mail meter 39 may be mailed from a location of the provider system 30 to a location of the customer system 20 as indicated by an arrow 51.

Various embodiments of the present invention are directed to systems and methods utilized for rewarding customer loyalty. Customers may be members of an organization, such as a club, a society, or the like, and may be charged payment amounts in the form of dues for membership in the organization. It is also possible that customers may be subscribers of goods or services, such as subscribers of cable services, satellite services, internet services, phone services, database services, newspapers, website content, or the like, and may be charged payment amounts in the form of service fees for the services. Moreover, customers may be purchasers of goods and may be charged payment amounts in the form of purchase prices for the goods. In various particular embodiments, customers may be members of a fitness club or gym, and may be charged payment amounts in the form of dues for membership in the fitness club or gym.

Various embodiments of the present invention are directed to rewarding customers for longevity of patronage with regard to a provider. Customers that are scheduled to be charged payment amounts specified by a payment plan are allowed to elect to be enrolled in a payment reducing plan. For example, the customers may be members of an organization who are scheduled to be charged payment amounts in the form of dues that are specified by a payment plan, such as a dues payment plan provided in a contract between the member and the organization, or the like, and the members may be allowed to elect to be enrolled in a payment reducing plan, which may be a dues reducing plan for reduction of the dues. As another example, the customers may be subscribers of goods or services and may be scheduled to be charged payment amounts in the form of service fees, subscription fees, or the like that are specified by a payment plan, such as a subscription fee plan provided in a contract between the subscriber and a subscription provider, or the like, and the subscriber may be allowed to elect to be enrolled in a payment reducing plan, which may be a service fees reducing plan for reduction of the service fees.

In various particular embodiments, a customer may be a member of a fitness club or gym who is already scheduled to be charged dues according to a dues payment plan provided in a contract between the member and the fitness club. For example, the member may be under contract to pay dues of $19.95 per month to the fitness club. The member of the fitness club may elect to enroll in a dues reducing plan, which may also be called a dues cutting plan, a dues savings plan, or the like. The dues reducing plan provides for an automatic reduction in the membership dues in accordance with a dues reduction schedule for the dues reducing plan while the member remains enrolled in the dues reducing plan. For example, the dues reduction schedule of the dues reducing plan may provide for a 10% reduction in the monthly membership dues every 10 months until a bottom rate of $9.95 is reached, at which time the monthly membership dues would remain at that minimum amount per month. It should be appreciated that the numbers in the example are merely provided as example numbers and that, in various embodiments, any desired fees, reduction of fees, and time for reduction of fees may be specified by the provider. Such dues reducing plans may improve member retention at fitness clubs by rewarding members for maintaining their memberships over long periods of time.

A provider, such as an organization, a service provider, or the like, may send an enrollment form to one or more customers through the mail, through e-mail, by fax, or the like, to allow the one or more customers to indicate a desire to enroll in a payment reducing plan. The enrollment form may include information about the payment reducing plan, such as information about a payment reduction schedule for the payment reducing plan, to provide an explanation of how payment amounts charged to the customer will be automatically reduced over time. The enrollment form may be sent to all customers of the provider, or may be sent to only selected customers of the provider that are selected based on some criteria, such as an amount of time they have been customers of the provider, or the like. The enrollment form may include a detachable portion with a check box, or the like, that a customer can check off and return in the mail, by e-mail, by fax, or the like, to indicate a desire to be enrolled in the payment reducing plan.

In various particular embodiments, the provider may be a fitness club, and the fitness club may send an enrollment form by mail, by e-mail, by fax, or the like, to one or more members of the fitness club to allow the one or more members to indicate a desire to enroll in a dues reducing plan. The enrollment form may include information about the dues reducing plan, such as information about a dues reduction schedule for the dues reducing plan to explain how the dues will be automatically reduced over time. The enrollment form may be sent to all members of the fitness club, or may be sent to only selected members that are selected based on some criteria, such as an amount of time they have been members of the fitness club, or the like. The enrollment form may include a detachable portion with a check box, or the like, that a member can check off and return in the mail, by e-mail, by fax, or the like, to indicate a desire to be enrolled in the dues reducing plan.

There may be a fee to enroll in the payment reducing plan that is separate from the payment amounts charged to the customer. The fee to enroll in the payment reducing plan may be a one-time lump sum fee, or may be spread out in an enrollment fee payment plan over time, such as, for example, paying $2 per month for 20 months. The enrollment form may include a section for the customer to indicate whether the customer would like to pay the one-time lump sum or make monthly payments for the payment reducing plan enrollment fee. Payment of the payment reducing plan enrollment fee may be made by cash, check, credit card, debit card, or the like, and the enrollment form may include a section for indicating the method of payment, and may include a section for specifying a credit card number and expiration date for credit card payments. The enrollment form and optional check for payment of the payment reducing plan enrollment fee may be mailed to the provider, or may be turned in at one or more locations designated by the provider. In some instances, the completed enrollment form may be e-mailed, faxed, or otherwise transmitted to the provider.

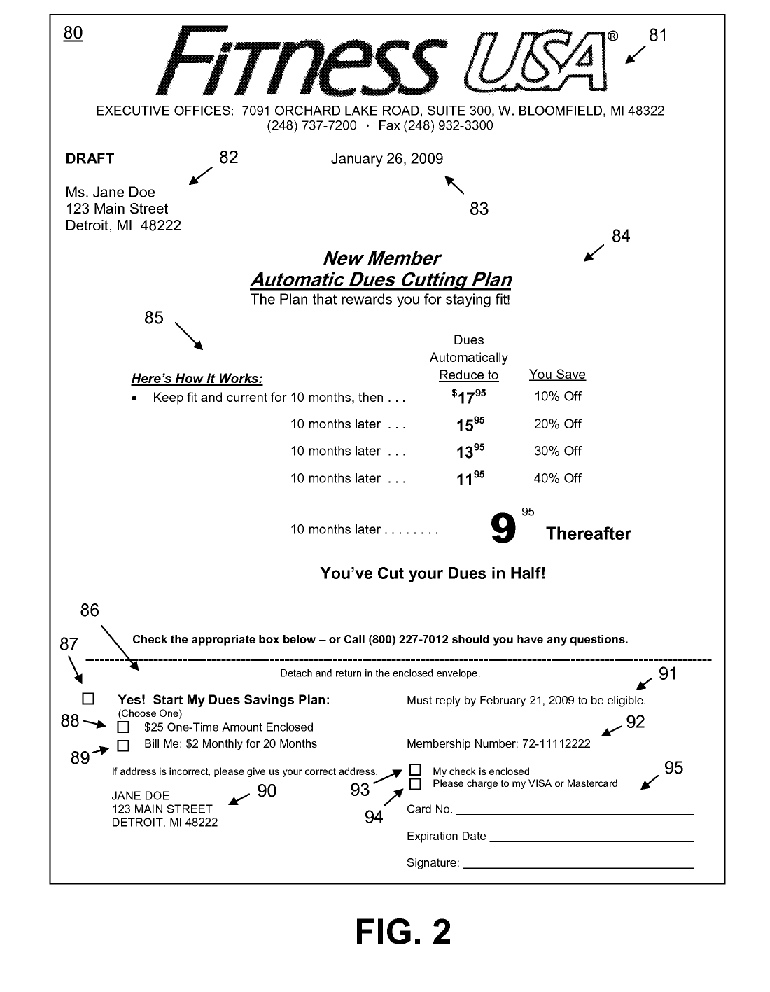

FIG. 2 is an enrollment form 80 in accordance with an embodiment of the present invention. The enrollment form 80 is an example of an enrollment form that may be mailed from a provider, such as a fitness club or the like, to a customer, such as a member of the fitness club. A provider identification section 81 of the enrollment form 80 indicates a name, address, phone number, fax number, and the like of the provider. A customer identification section 82 of the enrollment form 80 indicates a name, address, and the like of a customer to which the enrollment form is directed. A date section 83 of the enrollment form 80 indicates a date of printing, a date of mailing, or the like, of the enrollment form 80. A dues reducing plan section 84 of the enrollment form 80 explains to the customer that they have the opportunity to enroll in a dues reducing plan, which may also be called a dues cutting plan, a dues savings plan, or the like. A dues reduction schedule section 85 of the enrollment form 80 explains a dues reduction schedule for the dues reducing plan.

In the example of FIG. 2, the enrollment form 80 may be provided to a member of a fitness club who is already under contract with the fitness club to make payments under a payment plan that requires dues to be paid by the member in an amount of $19.95 per month. As is illustrated in the dues reduction schedule section 85 of the enrollment form 80, the member receiving the enrollment form 80 in the example of FIG. 2 is offered to enroll in a dues reducing plan, which may also be called a dues cutting plan or dues savings plan, with a dues reduction schedule that provides for a reduction in the dues owed by the member after each 10 month period that the member remains enrolled in the dues reducing plan.

Thus, in the example shown in FIG. 2, if the member were to enroll in the offered dues reducing plan, then according to the example dues reduction schedule the monthly dues owed by the member would be automatically reduced to $17.95 if the member remains enrolled in the dues reducing plan for 10 months, and would be automatically reduced to $15.95 if the member remained enrolled in the dues reducing plan for a further 10 months, and would be automatically reduced to $13.95 if the member remained enrolled in the dues reducing plan for a further 10 months, and would be automatically reduced to $11.95 if the member remained enrolled in the dues reducing plan for a further 10 months, and would be automatically reduced to $9.95 if the member remained enrolled in the dues reducing plan for a further 10 months. Thereafter, according to the example, the dues for the member would remain at the minimum rate of $9.95 per month if the member remained enrolled in the dues reducing plan.

The enrollment form 80 further includes an enrollment portion 86 that can be filled out by the member and returned to the fitness club to indicate that the member would like to be enrolled in the dues reducing plan. In the example, the dues reducing plan is also called a dues savings plan or dues cutting plan. A check box 87 of the enrollment portion 86 may be checked by the member to indicate that the member desires to be enrolled in the dues reducing plan. The enrollment portion 86 provides two options to the member for payment of an enrollment fee for enrolling in the dues reducing plan. A first option is to pay a one-time amount of $25 for the enrollment fee, and that option can be selected by checking a check box 88 of the enrollment portion 86. A second option is to pay $2 monthly for 20 months for the enrollment fee, and that option can be selected by checking a check box 89 of the enrollment portion 86.

An address correction section 90 of the enrollment portion 86 allows for the member to supply updated address information to the fitness club. An eligibility date section 91 of the enrollment portion 86 specifies a date by which the member must reply to the offer in order to qualify for the dues reducing plan. A membership number section 92 of the enrollment portion 86 specifies a current membership number assigned to the member. The enrollment portion 86 provides two options for types of payment for the enrollment fee. A first option is for the member to pay by check, and that option can be selected by checking a check box 93 of the enrollment portion 86. In such a case, the member may enclose the check with the enrollment portion 86 when returning the completed enrollment portion 86 back to the fitness club. A second option is for the member to pay by credit card, debit card, or the like, and that option can be selected by checking a check box 94 of the enrollment portion 86. In such a case, the member can fill out a card information section 95 of the enrollment portion 86 to specify a card number and an expiration date for a card to be used for the payment, and to provide a signature to authorize the payment. The enrollment portion 86 of the enrollment form 80 can be detached and returned, for example, in an envelope to the fitness club.

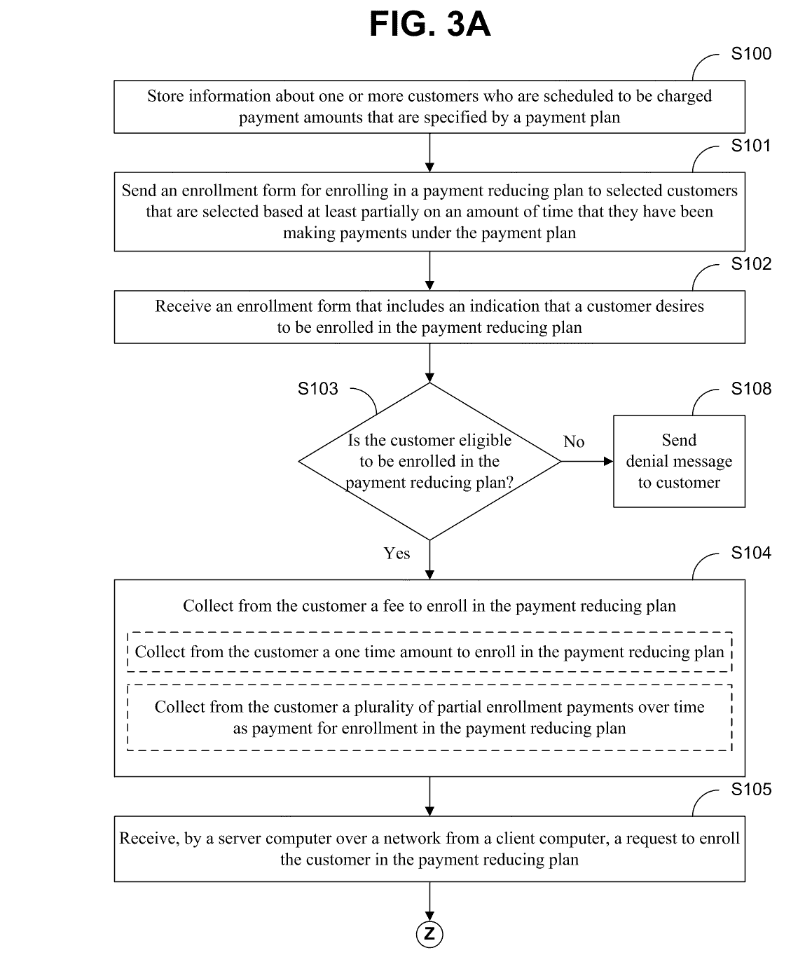

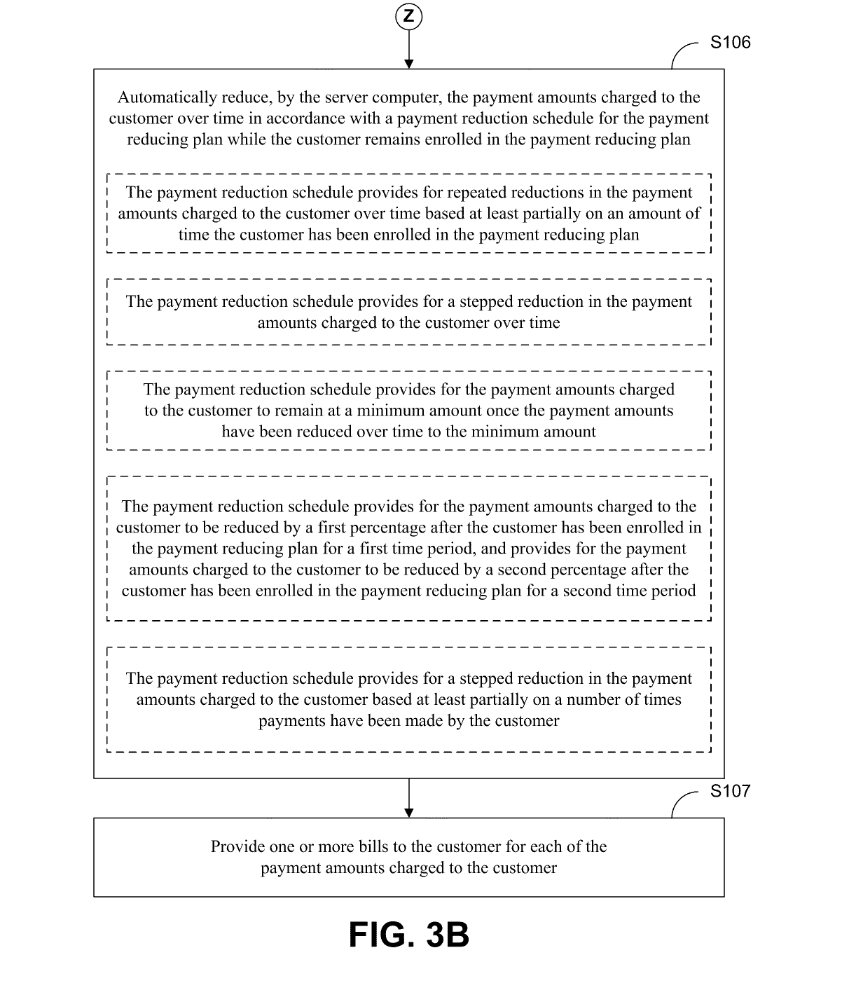

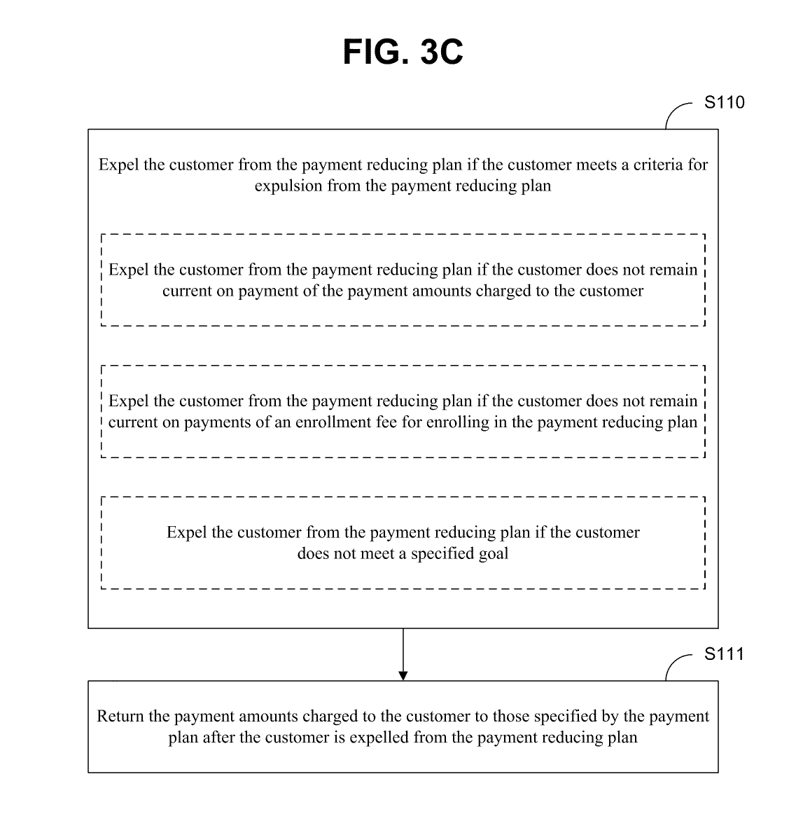

FIGS. 3A, 3B, and 3C are a flowchart of a method in accordance with an embodiment of the present invention. With reference to FIGS. 1 and 3A, in S100 the method includes storing information about one or more customers who are scheduled to be charged payment amounts that are specified by a payment plan. For example, customers may be under contract with a provider to make periodic payments specified by a payment plan in the contract. Information about each customer may include, for example, a name of the customer, a customer number assigned to the customer, an address of the customer, an indication of the payment plan under which the customer is scheduled to make payments, an amount of time that the customer has been making payments under the payment plan, or the like. Of course, it should be appreciated that the above types of information are merely provided as examples and that, in various embodiments, any desired information may be stored about the one or more customers. The information about the one or more customers may be stored, for example, in a database on the server computer 36, or may be stored in a database (not shown) separate from the server computer 36 that is accessible by the server computer 36 over the network 47 or by other means of communication. The method then continues to S101.

In S101, an enrollment form for enrolling in a payment reducing plan is sent to selected customers of a provider that are selected based at least partially on an amount of time that they have been making payments under the payment plan. For example, in various embodiments, the server computer 36 stores the database of customers of the provider as well as information as to how long the customers have been customers of the provider. The data entry computer 32 may be used to send a request over the network 47 to the server computer 36 to request the server computer 36 to execute a program stored on a computer-readable storage medium to query the database and return a list of customers that have been customers within a specified time range. As an example, the server computer 36 may return a list of customers that have been customers of the provider for less than three months.

The server computer 36 may further execute the program to obtain mailing addresses for each of the customers returned in the query, and to automatically cause enrollment forms for enrolling in a payment reducing plan to be printed by the mailing printer 37 for each of those customers, such that each enrollment form includes the address of the corresponding customer to which the enrollment form is directed. The enrollment forms printed by the mailing printer 37 may be supplied to the mail folder/inserter 38 to be packaged in envelopes, and may then be supplied to the mail meter 39 to place postage on the envelopes to send the envelopes through the mail to the customers. As another option, the server computer 36 may execute the program to obtain e-mail addresses for each of the customers to which the enrollment forms are to be sent, and then transmit the enrollment forms to the e-mail accounts of the customers through the Internet. The method then continues to S102.

A customer that receives an enrollment form to enroll in a payment reducing plan may then fill out the enrollment form and return the filled out enrollment form to the provider. The completed enrollment form may be received by the provider from the customer. If the enrollment form is received in the mail, the mail opening machine 31 may open an envelope holding the enrollment form. The completed enrollment form may be reviewed to confirm that the customer has marked the appropriate check box to indicate a desire to be enrolled in the payment reducing plan. It may be determined whether the customer is eligible to be enrolled in the payment reducing plan based on eligibility requirements. Example eligibility requirements may include, for example, the following: (a) determining whether the customer is current with payment of the payment amounts charged to the customer under a payment plan in which the customer is already enrolled, and declaring the customer ineligible for the payment reducing plan if the customer is not current with payment of the payment amounts already charged to the customer; (b) determining whether the enrollment form was returned within a reply time limit specified on the enrollment form, and declaring the customer ineligible for the payment reducing plan if the enrollment form was not returned within the time limit; and (c) determining whether the customer has made at least a partial payment of the payment reducing plan enrollment fee, and declaring the customer ineligible for the payment reducing plan if the customer has not made such a payment.

In various particular embodiments, the provider may be a fitness club, and an enrollment form may be received by the fitness club from a member of the fitness club. If the enrollment form is received in the mail, then the mail opening machine 31 may open the mail. The enrollment form may be reviewed to confirm that the member has marked the appropriate box to indicate a desire to be enrolled in a dues reducing plan. It may then be determined whether the member is eligible to be enrolled in the dues reducing plan based on eligibility requirements. Example eligibility requirements may include the following: (a) determining whether the member is current with payment of membership dues, and declaring the member ineligible for the dues reducing plan if the member is not current with payment of the membership dues; (b) determining whether the enrollment form was returned within a reply time limit specified on the enrollment form, and declaring the member ineligible for the dues reducing plan if the enrollment form was not returned within the time limit; and (c) determining whether the member has made at least a partial payment of the dues reducing plan enrollment fee, and declaring the member ineligible for the dues reducing plan if the member has not made such a payment.

With reference to FIGS. 1 and 3A, in S102, the provider receives an enrollment form that includes an indication that a customer desires to be enrolled in the payment reducing plan. The enrollment form may be provided, for example, to an employee of the provider working at the data entry computer 32. The method then continues to S103. In S103, it is determined whether the customer is eligible to be enrolled in the payment reducing plan. In some embodiments, a customer is ineligible for the payment reducing plan if the customer is not current with payments under the payment plan for which the customer is under contract. In some embodiments, the customer is ineligible for the payment reducing plan if the customer did not return the enrollment form by the deadline specified on the enrollment form. A request may be sent from the data entry computer 32 over the network 47 to the server computer 36 to have the server computer 36 query a database and return information to the data entry computer 32 concerning whether the customer is current with payments under the payment plan to which the customer is already under contract.

If it is determined in S103 that the customer is ineligible for the payment reducing plan, then the method continues to S108. In S108, a denial message is sent to the customer and the method ends. A denial message may be printed by the mailing printer 37 in accordance with a print job initiated from the data entry computer 32, and the denial message may be inserted into an envelope by the mail folder/inserter 38, and given postage by the mail meter 39 to be mailed to the customer. As another option, a denial message may be sent from the data entry computer 32 as an e-mail to an e-mail account of the customer. If it is determined in S103 that the customer is eligible for the payment reducing plan, then the method continues to S104.

A payment for an enrollment fee for enrolling in the payment reducing plan may be made by the customer by check, credit card, debit card, cash, or the like. If the payment is by check, the check may be deposited by the provider in a bank using a deposit slip. If the payment is by credit card, a data entry employee of the provider may enter the credit card information into the data entry computer 32, and a file may be created to include a customer number of the customer, a brief description to appear on a bank statement, a credit card number of the credit card of the customer, and an expiration date of the credit card of the customer. An employee of the provider may then log into the bank server 71 over the network 45 using the data entry computer 32 and transmit the file to the bank server 71 for credit card processing. As another option, the entry of the credit card information may be performed on a first computer, such as the data entry computer 32, by a data entry employee of the provider, and the transmission of the file to the bank server 71 may be performed on a second computer, such as the accounting computer 33, by an accounting employee of the provider.

The bank server 71 may return a status indication to the data entry computer 32 or the accounting computer 33 as to whether the payment processing succeeded or failed. If the payment processing fails and the customer has not yet been enrolled in the payment reducing plan, then the customer may be declared ineligible for the payment reducing plan. If the payment processing fails and the customer has already been enrolled in the payment reducing plan, then the customer may be expelled from the payment reducing plan and an employee of the provider may provide input to the data entry computer 32 to remove a credit from an account of the customer. A notification may be sent to the customer in a case where the payment processing has failed.

With reference to FIGS. 1 and 3A, in S104, a fee is collected from the customer for the customer to enroll in the payment reducing plan. As one option, a one time amount may be collected from the customer for the customer to enroll in the payment reducing plan. For example, the customer may pay a one-time amount of $25.00 as payment for enrollment in the payment reducing plan. As another option, a plurality of partial enrollment payments may be collected from the customer over time as payment for enrollment in the payment reducing plan. For example, the customer may be billed $2.00 monthly for 20 months as payment for enrollment in the payment reducing plan. It should be appreciated that the above examples are merely provided as examples of amounts of payments that can be made and that, in various embodiments, the provider can charge any desired price and can set any desired schedule for payment of a fee for enrollment in the payment reducing plan. The method then continues to S105.

In a case where a customer indicates a desire to be enrolled in the payment reducing plan and meets the eligibility requirements, an employee of the provider may enter into an input device of the data entry computer 32 information indicating that the customer is to be enrolled in the payment reducing plan. The data entry computer 32 may be networked to the server computer 36, and the data entry computer 32 may send the information over the network 47 to the server computer 36 to be stored in a database on the server computer 36. In an embodiment, upon receiving the information indicating that the customer is to be enrolled in the payment reducing plan, the server computer 36 automatically schedules the payment amounts charged to the customer to be reduced in accordance with a corresponding payment reduction schedule as long as periodic payment amounts charged to the customer are paid by the customer on time. There may be different payment reduction schedules for different payment reducing plans.

In various particular embodiments, the provider may be a fitness club, and in a case where a member of the fitness club indicates a desire to be enrolled in a dues reducing plan and meets eligibility requirements, an employee of the fitness club may enter into an input device of the data entry computer 32 information indicating that the member is to be enrolled in the dues reducing plan. The data entry computer 32 may be networked to the server computer 36, and the data entry computer 32 may send the information over the network 47 to the server computer 36 to be stored in a database on the server computer 36. Upon receiving the information indicating that the member is to be enrolled in the dues reducing plan, the server computer 36 automatically schedules the membership dues for the member to be reduced in accordance with a corresponding dues reduction schedule as long as periodic dues payments are made on time by the member. There may be different dues reduction schedules for different dues savings plans.

With reference to FIGS. 1 and 3A, in S105, the server computer 36 receives over the network 47 from a client computer, such as the data entry computer 32, a request to enroll the customer, who is already scheduled to be charged payment amounts specified by the payment plan, in the payment reducing plan. For example, the customer may already be scheduled to be charged payments amounts of $19.95 per month specified by a payment plan in a contract between the customer and the provider, and the server computer 36 may receive a request from the data entry computer 32 to enroll the customer in a payment reducing plan. The server computer 36 may execute a program stored on a computer-readable storage medium, where the program when executed allows the server computer 36 to receive the request from the data entry computer 32 over the network 47. The method then continues to S106 (refer to FIG. 3B).

In an embodiment, the server computer 36 executes a program from a computer-readable storage medium that causes the server computer 36 to automatically reduce the payment amounts charged to the customer in accordance with the payment reduction schedule while the customer remains enrolled in the payment reducing plan. In an embodiment, the payment reduction schedule may provide for repeated reductions of the payment amounts charged to the customer based at least partially on an amount of time the customer has been enrolled in the payment reducing plan. Also, in an embodiment, the payment reduction schedule may provide for a stepped reduction in payment amounts charged to the customer over time. For example, the payment reduction schedule may provide for an X % reduction in the payment amounts charged to the customer after each Y month period, where X and Y are variables specified by the provider for the payment reducing plan. The payment reduction schedule may also provide for the payment amounts charged to the customer to remain at a specific base amount once the payment amounts charged to the customer have been reduced over time to the base amount. As another example, the payment reduction schedule may provide for a stepped reduction in the payment amounts charged to the customer based at least partially on a number of times payment amounts charged to the customer have been paid by the customer while the customer has been enrolled in the payment reducing plan. The server computer 36 may print a notice for the customer using the mailing printer 37 to indicate the current payment amounts charged to the customer after each reduction in the payment amounts charged to the customer.

In various particular embodiments, the provider may be a fitness club, and the server computer 36 may automatically reduce the dues charged to a member of the fitness club in accordance with the dues reduction schedule while the member remains enrolled in the dues reducing plan. The dues reduction schedule may provide for repeated reductions of the dues based at least partially on an amount of time the member has been enrolled in the dues reducing plan. Also, the dues reduction schedule may provide for a stepped reduction in dues over time. For example, the dues reduction schedule may provide for a 10% reduction in an amount for the membership dues after each 10 month period. The dues reduction schedule may also provide for the dues to remain at a specific base amount once the dues have been reduced over time to the base amount. As another example, the dues reduction schedule may provide for a stepped reduction in an amount for the membership dues based at least partially on a number of times dues have been paid by the member while the member has been enrolled in the dues reducing plan. The server computer 36 may print a notice using the mailing printer 37 for the member to indicate the current dues rate after each dues reduction.

With reference to FIGS. 1 and 3B, in S106, the server computer 36 automatically reduces the payment amounts charged to the customer over time in accordance with a payment reduction schedule for the payment reducing plan while the customer remains enrolled in the payment reducing plan. In an embodiment, the payment reduction schedule provides for repeated reductions in the payment amounts charged to the customer over time based at least partially on an amount of time the customer has been enrolled in the payment reducing plan. The payment reduction schedule may provide for a stepped reduction in the payment amounts charged to the customer over time. The payment reduction schedule may also provide for the payment amounts charged to the customer to remain at a minimum amount once the payment amounts have been reduced over time to the minimum amount. In an embodiment, the payment reduction schedule provides for the payment amounts charged to the customer to be reduced by a first percentage after the customer has been enrolled in the payment reducing plan for a first time period, and provides for the payment amounts charged to the customer to be reduced by a second percentage after the customer has been enrolled in the payment reducing plan for a second time period. In an embodiment, the payment reduction schedule provides for a stepped reduction in the payment amounts charged to the customer based at least partially on a number of times payments have been made by the customer to the provider. The method continues to S107.

In S107, one or more bills are provided to the customer for each of the payment amounts charged to the customer. The server computer 36 may send information about a payment amount to be charged to the customer to the mailing printer 37 to print a bill to be sent to the customer specifying the payment amount owed by the customer. The bill printed by the mailing printer 37 may be inserted in an envelope by the mail folder/inserter 38 and may be provided with postage by the mail meter 39 to be mailed to the customer through the postal system. As another option, the server computer 36 may send an e-mail to an e-mail account of the customer to indicate the payment amount owed by the customer.

A customer may be expelled from the payment reducing plan for various reasons, such as the following: (a) the customer may be expelled from the payment reducing plan if the customer does not remain current on payment of the payment amounts charged to the customer; (b) the customer may be expelled from the payment reducing plan if the customer does not remain current on payment of the enrollment fee for enrolling in the payment reducing plan; and (c) the customer may be expelled from the payment reducing plan if the customer does not meet a certain fitness goal, such as a weight reduction goal, a strength improvement goal, an attendance requirement for a fitness class, or the like. Once a customer has been expelled from the payment reducing plan, the payment amounts charged to the customer may return to the original payment amounts charged to the customer as specified in the payment plan.

With reference to FIGS. 1 and 3C, in S110, the customer is expelled from the payment reducing plan if the customer meets a criteria for expulsion from the payment reducing plan. In an embodiment, the determination for expelling the customer in S110 occurs while the customer is enrolled in the payment reducing plan in S106. The server computer 36 may execute a program stored on a computer-readable storage medium to query a database on the server computer 36 storing customer information to determine whether the customer meets the criteria for expulsion from the payment reducing plan. In an embodiment, when information is entered into the server computer 36 relating to the customer, the server computer 36 automatically determines whether the entered information includes a reason for expelling the customer from the payment reducing plan, and then automatically expels the customer from the payment reducing plan if the customer is to be expelled from the payment reducing plan.

The customer may be expelled from the payment reducing plan if the customer does not remain current on payment of the payment amounts charged to the customer. Also, the customer may be expelled from the payment reducing plan if the customer does not remain current on payments of an enrollment fee for enrolling in the payment reducing plan. The customer may be expelled from the payment reducing plan if the customer does not meet a specified goal. The specified goal may be, for example, a weight reduction goal, a strength improvement goal, a class attendance goal, or the like. The method then continues to S111. In S111, the payment amounts charged to the customer return to those specified by the payment plan if the customer is expelled from the payment reducing plan.

Various embodiments described above with reference to FIGS. 1, 3A, 3B, and 3C include the performance of various processes or tasks. Such processes or tasks may be performed through the execution of computer code read from computer-readable storage media. For example, one or more computer-readable storage mediums may store one or more computer programs that, when executed by the server computer 36, cause the server computer 36 to perform processes or tasks as described with respect to the server computer 36 in the above embodiments. Also, one or more computer-readable storage mediums may store one or more computer programs that, when executed by the data entry computer 32, cause the data entry computer 32 to perform processes or tasks as described with respect to the data entry computer 32 in the above embodiments.

Thus, embodiments within the scope of the present invention include program products comprising computer-readable or machine-readable media for carrying or having computer or machine executable instructions or data structures stored thereon. Such computer-readable storage media can be any available media that can be accessed, for example, by a general purpose or special purpose computer or other machine with a processor. By way of example, such computer-readable storage media can comprise semiconductor memory, flash memory, hard disks, optical disks such as compact disks (CDs) or digital versatile disks (DVDs), magnetic storage, random access memory (RAM), read only memory (ROM), and/or the like. Combinations of those types of memory are also included within the scope of computer-readable storage media. Computer-executable program code may comprise, for example, instructions and data which cause a computer or processing machine to perform certain functions, calculations, actions, or the like.

A computer-readable storage medium in accordance with an embodiment stores a computer program that when executed on the server computer 36 causes the server computer 36 to perform a process. The process may comprise storing information about a customer scheduled to be charged payment amounts specified by a payment plan. The process may further comprise receiving, by the server computer 36 over the network 47 from a client computer, such as the data entry computer 32, a request to enroll the customer in a payment reducing plan. Also, the process may further comprise automatically reducing, by the server computer 36, the payment amounts charged to the customer over time in accordance with a payment reduction schedule for the payment reducing plan while the customer remains enrolled in the payment reducing plan.

A system, such as the provider system 30, or the like, in accordance with an embodiment of the invention comprises the server computer 36 and a client computer, such as the data entry computer 32, or the like. The server computer 36 may be configured to store information about a customer who is scheduled to be charged payment amounts that are specified by a payment plan. The server computer 36 may also be configured to receive, over the network 47 from a client computer, such as the data entry computer 32, a request to enroll the customer in a payment reducing plan. Furthermore, the server computer 36 may be configured to automatically reduce the payment amounts charged to the customer over time in accordance with a payment reduction schedule for the payment reducing plan while the customer remains enrolled in the payment reducing plan.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. Various modifications and changes that come within the meaning and range of equivalency of the claims are intended to be within the scope of the invention.

What is claimed is:

1. A method for rewarding customer loyalty, comprising:
storing information about a customer scheduled to be charged payment amounts specified by a payment plan;
receiving, by a server computer over a network from a client computer, a request to enroll the customer in a payment reducing plan; and
automatically reducing, by the server computer, the payment amounts charged to the customer over time in accordance with a payment reduction schedule for the payment reducing plan while the customer remains enrolled in the payment reducing plan.

2. The method of claim 1,
wherein the customer is a member of a club; and
wherein the payment amounts are membership dues for membership in the club.

3. The method of claim 1,
wherein the customer is a subscriber to a service; and
wherein the payment amounts are service charges for usage of the service.

4. The method of claim 1, further comprising:
sending an enrollment form for enrolling in the payment reducing plan to selected customers that are selected based at least partially on an amount of time that they have been making payments under the payment plan.

5. The method of claim 1, further comprising:
collecting from the customer a one time amount to enroll in the payment reducing plan.

6. The method of claim 1, further comprising:
collecting from the customer a plurality of partial enrollment payments over time as payment for enrollment in the payment reducing plan.

7. The method of claim 1,
the payment reduction schedule providing for repeated reductions in the payment amounts charged to the customer over time based at least partially on an amount of time the customer has been enrolled in the payment reducing plan.

8. The method of claim 1,
the payment reduction schedule providing for a stepped reduction in the payment amounts charged to the customer over time.

9. The method of claim 1,
the payment reduction schedule providing for the payment amounts charged to the customer to remain at a minimum amount once the payment amounts have been reduced over time to the minimum amount.

10. The method of claim 1,
the payment reduction schedule providing for the payment amounts charged to the customer to be reduced by a first percentage after the customer has been enrolled in the payment reducing plan for a first time period, and providing for the payment amounts charged to the customer to be reduced by a second percentage after the customer has been enrolled in the payment reducing plan for a second time period.

11. The method of claim 1,
the payment reduction schedule providing for a stepped reduction in the payment amounts charged to the customer based at least partially on a number of times payments have been made by the customer.

12. The method of claim 1, further comprising:
expelling the customer from the payment reducing plan if the customer does not remain current on payment of the payment amounts charged to the customer.

13. The method of claim 12,
wherein the payment amounts charged to the customer return to those specified by the payment plan after the customer is expelled from the payment reducing plan.

14. The method of claim 1, further comprising:
expelling the customer from the payment reducing plan if the customer does not remain current on payments of an enrollment fee for enrolling in the payment reducing plan.

15. The method of claim 1, further comprising:
expelling the customer from the payment reducing plan if the customer does not meet a specified goal;
wherein the specified goal includes at least one of a weight reduction goal, a strength improvement goal, or a class attendance goal.

16. The method of claim 1, further comprising:
receiving an enrollment form that includes an indication that the customer desires to be enrolled in the payment reducing plan.

17. The method of claim 16, further comprising:
determining whether the customer is to be enrolled in the payment reducing plan based at least partially on a date of submission of the enrollment form.

18. The method of claim 1, further comprising:
providing one or more bills to the customer for each of the payment amounts charged to the customer.

19. A computer-readable storage medium storing a computer program that when executed on a server computer causes the server computer to perform a process, the process comprising:
storing information about a customer scheduled to be charged payment amounts specified by a payment plan;
receiving, by the server computer over a network from a client computer, a request to enroll the customer in a payment reducing plan; and
automatically reducing, by the server computer, the payment amounts charged to the customer over time in accordance with a payment reduction schedule for the payment reducing plan while the customer remains enrolled in the payment reducing plan.

20. A system, comprising:
a client computer; and
a server computer;
the server computer configured to store information about a customer scheduled to be charged payment amounts specified by a payment plan;
the server computer configured to receive, over a network from the client computer, a request to enroll the customer in a payment reducing plan; and
the server computer configured to automatically reduce the payment amounts charged to the customer over time in accordance with a payment reduction schedule for the payment reducing plan while the customer remains enrolled in the payment reducing plan.
